(19) United States
(12) Patent Application Publication
(10) Pub. No.: US 2026/0354308 A1
(43) Pub. Date: Nov. 12, 2026

(54) SINGLE-ROW SELF-PROPELLED AUTOMATIC HARVESTING EQUIPMENT FOR PREMIUM TEA SHOOTS

(71) Applicant: Anhui Agricultural University, Hefei (CN)

(72) Inventors: Zhengmin Wu, Hefei (CN); Yiyong Wang, Hefei (CN); Tong Gao, Hefei (CN); Kun Luo, Hefei (CN); Xuechen Zhang, Hefei (CN); Chengmao Cao, Hefei (CN); Kuan Qin, Hefei (CN)

(21) Appl. No.: 19/279,217

(22) Filed: Jul. 24, 2025

(30) Foreign Application Priority Data
May 7, 2025 (CN) 2025105842644

(51) Int. Cl. A01D 46/30

(52) U.S. Cl. CPC A01D 46/30

(57) ABSTRACT

The present invention discloses a single-row self-propelled automatic harvester for premium tea shoots, comprising a base with a traveling mechanism, fixed guide rail assembly, picking mechanism, collecting mechanism, storage bin, and control system. The guide rail features front/rear positioning holes, with the rear hole comprising lower vertical, horizontal, and upper vertical segments. A rack is disposed beside the upper segment. The picking mechanism slides in the front hole for tea shoot harvesting. The collecting mechanism includes a sliding rod in the rear hole, pivoting lever with gear, and gathering hopper. Crucially, the decoupled arrangement of picking and collecting mechanisms allows larger hopper capacity, reducing transfer cycles. During operation, the sliding rod traverses the rear hole while the gear engages the rack, driving hopper rotation to discharge shoots into the storage bin, achieving automated transfer.

### TECHNICAL FIELD

The present invention relates to the technical field of tea harvesting, and particularly relates to a single-row self-propelled automatic harvesting equipment for premium tea shoots.

### BACKGROUND

China is a major tea-producing country. With the continuous development of the social economy and the intensification of the population aging problem, the labor resources in China are gradually becoming scarce. As a labor-intensive industry, the tea industry requires a large amount of labor in processes such as planting, cultivation, harvesting, and tea processing. Particularly in harvesting, due to the time-sensitive nature of plucking tender tea shoots, once the plucking period passes, the tender tea shoots become over-mature, resulting in inferior flavor and inability to produce high-quality tea. Currently, tea harvesting has already faced a problem of labor shortage; thus, mechanized tea harvesting has become the general trend for the tea industry.

As disclosed in Chinese Invention Patent Application Publication No. CN117958027A, a small single-track self-propelled tea harvester is provided. The harvester comprises a base, a track, a collection box, an installation platform, a serial robotic arm, an end-effector, and a depth camera. The track is disposed at a bottom surface of the base. The installation platform is disposed on a top surface of the base, and the serial robotic arm is mounted on a top surface of the installation platform. The end-effector includes a reciprocating cutter and a temporary storage box. The temporary storage box is mounted at a distal end of the serial robotic arm. A feed inlet is disposed on a side of the temporary storage box. The reciprocating cutter is mounted on a bottom surface of the temporary storage box adjacent to the feed inlet, configured to cut tea shoots. The collection box is disposed on the top surface of the base. Fresh tea shoots are cut by the reciprocating cutter and stored in the temporary storage box; then, the tea shoots within the temporary storage box are discharged into the collection box for collection by the movement of the end-effector driven by the serial robotic arm.

Regarding the aforementioned prior art, the inventor has identified the following drawbacks: In the described solution, the reciprocating cutter is installed at the feed inlet of the temporary storage box, and the temporary storage box is mounted at the distal end of the serial robotic arm. The serial robotic arm drives both the temporary storage box and the reciprocating cutter to move for cutting tea shoots and subsequently transferring the tea shoots from the temporary storage box into the collection box. This necessitates that the temporary storage box undergoes synchronized movement and angular adjustments with the reciprocating cutter. Consequently, the temporary storage box cannot be overly large and is unable to store a substantial amount of tea shoots. As a result, the serial robotic arm must be operated frequently to discharge the tea shoots within the temporary storage box into the collection box, thereby affecting harvesting efficiency.

### SUMMARY OF THE INVENTION

To address the above problems, the present invention provides a single-row self-propelled automatic harvesting equipment for premium tea shoots.

The aforementioned technical objective of the present invention is achieved through the following technical solution: A single-row self-propelled automatic harvesting equipment for premium tea shoots comprises a base. A traveling mechanism is disposed at a bottom of the base. A fixed guide rail assembly, a picking mechanism, a collecting mechanism, a storage bin, and a control system are disposed on the base. The fixed guide rail assembly is provided with a first positioning hole and a second positioning hole arranged sequentially from front to rear, both being overall vertically oriented. The second positioning hole is divided, from bottom to top, into a lower vertical hole, a horizontal linking passage, and an upper vertical hole. The upper vertical hole is located on a rear side wall of the fixed guide rail assembly. A second rack, vertically disposed, is arranged on a side of the upper vertical hole proximate to the lower vertical hole. The picking mechanism is slidably disposed within the first positioning hole, configured to harvest tea shoots and convey them rearward. The collecting mechanism comprises a sliding rod slidably disposed within the second positioning hole. A pivoting lever is rotatably disposed at an outer end of the sliding rod. A gear is fixedly disposed on the pivoting lever. A gathering hopper is disposed at an outer end of the pivoting lever. The storage bin is located on the rear side of the fixed guide rail assembly and has a height lower than a bottom end of the upper vertical hole. When the sliding rod is located in a lower segment of the lower vertical hole, an opening of the gathering hopper faces toward the picking mechanism, configured to collect the harvested tea shoots. During upward sliding of the sliding rod within the upper vertical hole from bottom to top, the gear meshes with the second rack, causing the gathering hopper to rotate counter-clockwise and discharge the tea shoots into the storage bin. The control system is configured to provide power to the respective mechanisms and control their movements.

Further, a first rack vertically disposed is provided on a side of the lower vertical hole proximate to the upper vertical hole. During upward sliding of the sliding rod within the lower vertical hole from bottom to top, the gear meshes with the first rack, thereby causing the gathering hopper to rotate clockwise.

Further, a first lead screw is vertically and rotatably disposed within the fixed guide rail assembly. A first nut seat is threadedly engaged with the first lead screw. The picking mechanism includes a cantilevered arm, an inner end of which is slidably disposed within the first positioning hole. The first nut seat is fixedly connected to the inner end of the cantilevered arm. A first drive motor is disposed on the base. An output shaft of the first drive motor is connected to a bottom end of the first lead screw via a first reducer.

Further, a mounting bracket is disposed under the cantilevered arm. Two vertical plates are spaced apart within the mounting bracket. A worm, parallel to the cantilevered arm, is rotatably disposed between the two vertical plates. A short shaft is respectively arranged on an outer side of each vertical plate facing away from the other. A rotating sleeve is rotatably fitted over each short shaft. A rotary frame is commonly connected below the two rotating sleeves. A worm gear meshing with the worm is rotatably mounted within the rotary frame. Both ends of a shaft of the worm gear extend through the rotary frame and are commonly connected to a linkage frame below. A rotary cutter is disposed at a bottom of the linkage frame.

Further, a first servo motor and a second servo motor are respectively disposed at two ends within the mounting bracket; an end of the worm proximate to the first servo motor extends through the corresponding vertical plate and the corresponding short shaft and is connected to an output shaft of the first servo motor; and an output shaft of the second servo motor is connected to the corresponding rotating sleeve.

Further, a second lead screw is vertically and rotatably disposed within the fixed guide rail assembly; a second nut seat is threadedly engaged with the second lead screw; the second nut seat is fixedly connected to an inner end of the sliding rod; a second drive motor is disposed on the base; and an output shaft of the second drive motor is connected to a bottom end of the second lead screw via a second reducer.

Further, the control system comprises a control cabinet disposed on the base; a rechargeable battery and a controller are disposed within the control cabinet; the rechargeable battery supplies electrical power to the mechanisms; and the controller is configured to control the movements of the mechanisms.

Further, the control cabinet is disposed on a rear side of the fixed guide rail assembly; a mounting frame is arranged on the control cabinet; and the storage bin is placed within the mounting frame.

Further, a laser scanner and an industrial camera are disposed on a front portion of a top of the fixed guide rail assembly. The laser scanner and the industrial camera are configured to identify terrain information of a tea plantation and, via the controller, plan a travel path for the traveling mechanism. A depth-sensing camera is disposed on the top of the fixed guide rail assembly adjacent to the picking mechanism. The depth-sensing camera is configured to identify tea canopy surface information and, via the controller, adjust a picking height and a picking angle of the picking mechanism.

In summary, the present invention provides the following beneficial effects: In this application, the picking mechanism and the collecting mechanism are arranged separately. They move independently within the first positioning hole and the second positioning hole respectively, while maintaining coordinated interaction. This configuration enables the gathering hopper of the collecting mechanism to be designed without size restrictions, thereby allowing it to accommodate a larger volume of tea shoots, reducing the number of transfer cycles for the tea shoots, and improving harvesting efficiency. The second positioning hole is divided into three segments. Through the arrangement of the second rack, sliding rod, pivoting lever, and gear, the sliding rod, together with the pivoting lever and gathering hopper, moves along the second positioning hole. During movement of the sliding rod within the lower vertical hole and the horizontal linking passage, the gathering hopper is positioned above the storage bin at the rear side of the fixed guide rail assembly. When the sliding rod moves within the upper vertical hole, the gathering hopper ascends and, under the meshing action between the gear and the second rack, undergoes counter-clockwise rotation. This causes the opening of the gathering hopper to flip downward, discharging the tea shoots into the storage bin and achieving the transfer of the tea shoots.

### DESCRIPTION OF THE DRAWINGS

FIG. 1 is a schematic diagram of the overall structure of an embodiment of the present invention;

FIG. 2 is a structural schematic showing a state where the collecting mechanism transports tea shoots in an embodiment of the present invention;

FIG. 3 is a structural schematic of a fixed guide rail assembly in an embodiment of the present invention;

FIG. 4 is a structural schematic of a picking mechanism in an embodiment of the present invention;

FIG. 5 is a structural schematic of a mounting bracket, a rotary frame, and a linkage frame in an embodiment of the present invention;

FIG. 6 is a cross-sectional structural schematic taken from FIG. 5;

FIG. 7 is a structural schematic of a collecting mechanism in an embodiment of the present invention.

In the figures: 10, Base; 11, Traveling mechanism; 12, First drive motor; 13, First reducer; 14, Second drive motor; 15, Second reducer; 20, Fixed guide rail assembly; 21, First positioning hole; 22, Second positioning hole; 221, Lower vertical hole; 222, horizontal linking passage; 223, Upper vertical hole; 23, Second rack; 24, First rack; 25, First lead screw; 26, First nut seat; 27, Second lead screw; 28, Second nut seat; 30, Picking mechanism; 31, Cantilevered arm; 32, Rotary cutter; 33, Mounting bracket; 331, Vertical plate; 332, Worm; 333, Short shaft; 334, Rotating sleeve; 34, Rotary frame; 341, Worm gear; 35, Linkage frame; 36, First servo motor; 37, Second servo motor; 40, Collecting mechanism; 41, Sliding rod; 42, Pivoting lever; 43, Gear; 44, Gathering hopper; 50, Storage bin; 51, Fixing frame; 60, Control system; 61, Control cabinet; 62, Battery; 63, Controller; 70, LiDAR; 80, Industrial camera; 90, Depth-sensing camera.

### DETAILED DESCRIPTION

Hereinafter, the technical solutions in the embodiments of the present application will be clearly and completely described in conjunction with the accompanying drawings in the embodiments of the present application. It is apparent that the described embodiments are merely a part of the embodiments of the present application, and not all of them. All other embodiments obtained by a person of ordinary skill in the art based on the embodiments herein without creative effort shall fall within the scope of protection of the present application.

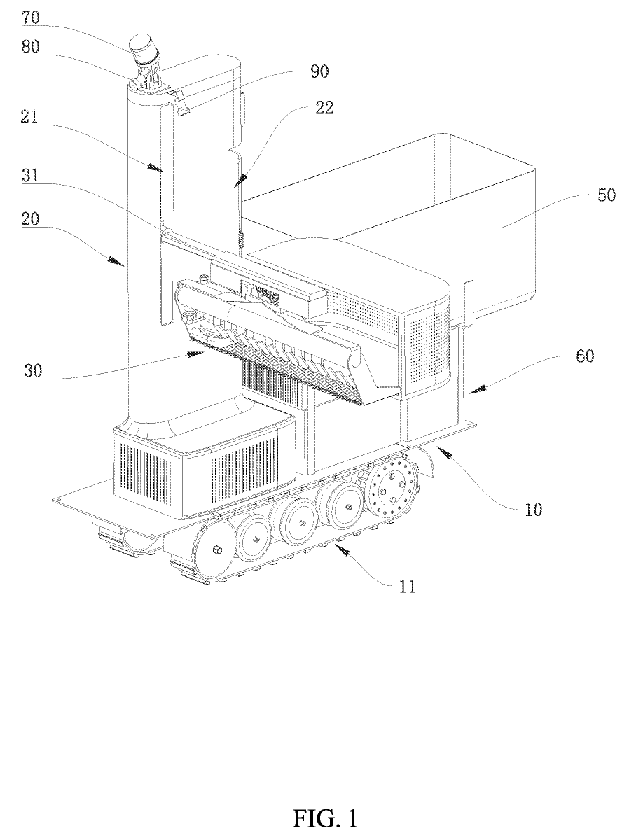

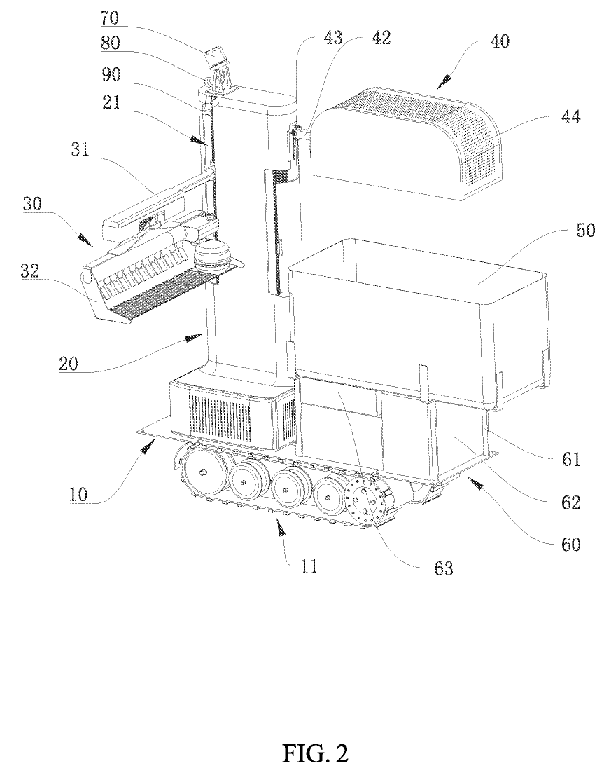

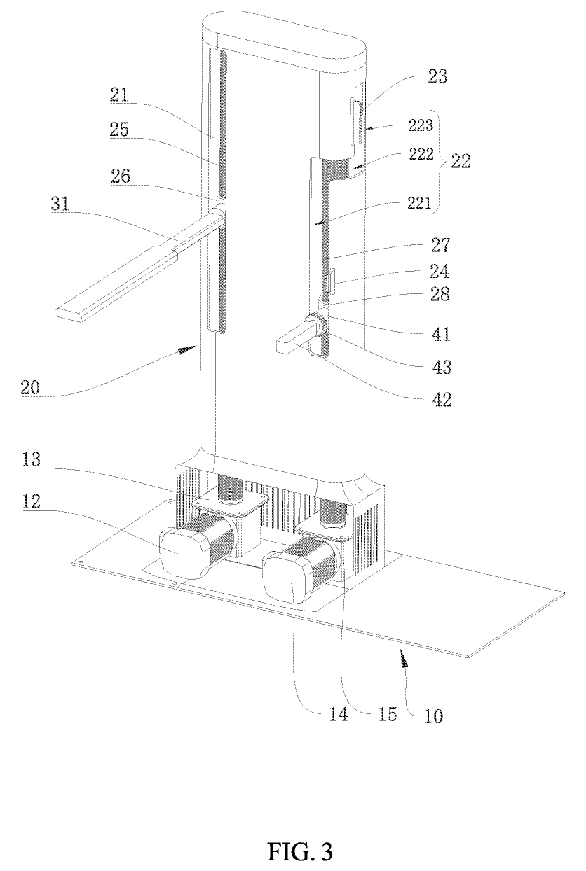

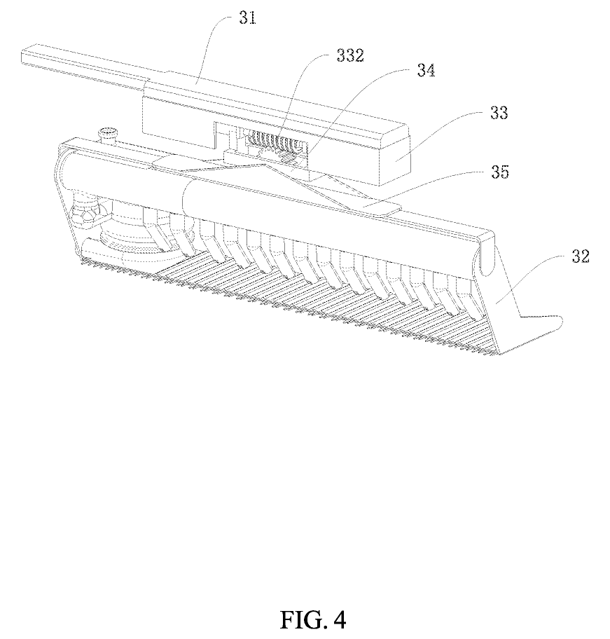

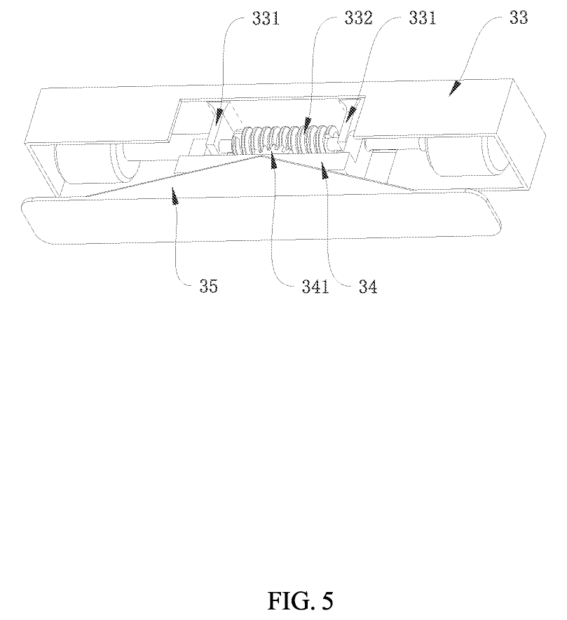

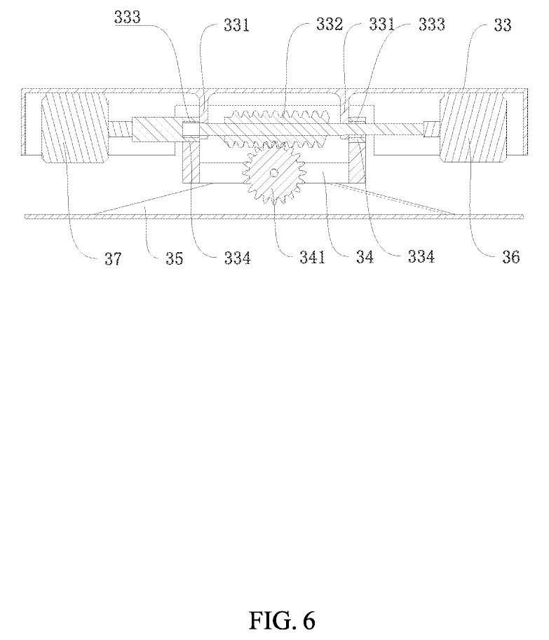

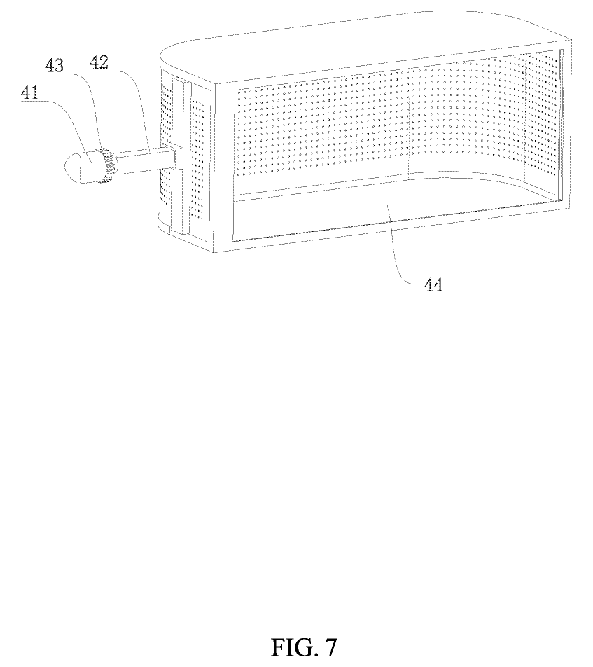

As shown in FIGS. 1-7, the embodiment of the present application discloses a single-row self-propelled automatic harvesting equipment for premium tea shoots. The equipment comprises a base 10, a traveling mechanism 11, a fixed guide rail assembly 20, a picking mechanism 30, a collecting mechanism 40, a storage bin 50, and a control system 60. The traveling mechanism 11 is disposed at the bottom of the base 10, adopting a dual-track configuration to drive the base 10 and its mounted components. The fixed guide rail assembly 20 is arranged on the base 10 and serves to mount the picking mechanism 30 and the collecting mechanism 40. The picking mechanism 30 is configured to harvest tea shoots and convey them rearward. The collecting mechanism 40 collects the tea shoots harvested by the picking mechanism 30. The storage bin 50 is positioned on the rear side of the fixed guide rail assembly 20 and is configured to receive and store the tea shoots transported by the collecting mechanism 40. The control system 60 provides power to all mechanisms and controls their movements.

Specifically, the fixed guide rail assembly 20 comprises a vertically oriented housing structure with an obround cross-section. It is provided with a first positioning hole 21 and a second positioning hole 22, both extending vertically from front to rear. The picking mechanism 30 is slidably disposed within the first positioning hole 21, while the collecting mechanism 40 is slidably disposed within the second positioning hole 22.

When set, the first positioning hole 21 is opened on the side wall of the fixed guide table 20 parallel to the advancing direction of the machine, and the whole of the first positioning hole 21 is a vertical strip-shaped hole. The picking mechanism 30 comprises a cantilevered arm 31, the inner end of which is slidably disposed within the first positioning hole 21. The cantilevered arm 31 extends perpendicularly to the machine's travel direction. A first lead screw 25 is vertically and rotatably disposed within the fixed guide rail assembly 20. A first nut seat 26 is threadedly engaged with the first lead screw 25, and this first nut seat 26 is fixedly connected to the inner end of the cantilevered arm 31. A first drive motor 12 is disposed on the base 10, with its output shaft connected to the bottom end of the first lead screw 25 via a first reducer 13. Actuation of the first drive motor 12 drives the first reducer 13 to rotate the first lead screw 25. This rotation propels the first nut seat 26 engaged with the lead screw. Since the first nut seat 26 is fixedly connected to the inner end of the cantilevered arm 31, and the cantilevered arm 31 is horizontally constrained within the first positioning hole 21, the first nut seat 26 is prevented from rotating with the first lead screw 25. Consequently, rotation of the first lead screw 25 drives the first nut seat 26 and the cantilevered arm 31 to undergo vertical movement along the first positioning hole 21.

A mounting bracket 33 is disposed under the cantilevered arm 31. Within the mounting bracket 33, two vertical plates 331 are spaced apart. A worm 332 parallel to the cantilevered arm 31 is rotatably disposed between the two vertical plates 331. A short shaft 333 is respectively arranged on each outer side of the vertical plates 331 facing away from the other, with each short shaft 333 being coaxial with the worm 332. A rotating sleeve 334 is rotatably fitted over each short shaft 333. Below these rotating sleeves 334, a rotary frame 34 is commonly connected to both sleeves, thereby enabling the rotary frame 34 to pivot about the axes of the short shafts 333. Within the rotary frame 34, a worm gear 341 meshing with the worm 332 is rotatably mounted. The shaft of the worm gear 341 is rotationally supported on both sides of the rotary frame 34. Both ends of this shaft extend through the rotary frame 34 and are commonly connected to a linkage frame 35 below, thereby enabling the linkage frame 35 to pivot conjointly with the worm gear 341 and its shaft relative to the rotary frame 34. A rotary cutter 32 is disposed at the bottom of the linkage frame 35. In this embodiment, the rotary cutter 32 employs the harvesting component of an SV100 dual-operator (flat-type) tea harvester. An air-blowing structure is integrated thereon to propel harvested tea shoots rearward, significantly ensuring collection efficiency of the collecting mechanism 40 while reducing the likelihood of tea shoot drop-off. As this rotary cutter 32 constitutes known prior art, it will not be elaborated herein.

Within the mounting bracket 33, a first servo motor 36 and a second servo motor 37 are respectively disposed at opposite ends. An end of the worm 332 proximate to the first servo motor 36 extends through the corresponding vertical plate 331 and short shaft 333 and is connected to the output shaft of the first servo motor 36. The output shaft of the second servo motor 37 is connected to the corresponding rotating sleeve 334. Actuation of the first servo motor 36 drives the worm 332 to rotate, thereby rotating the worm gear 341. This rotation drives the linkage frame 35 and the rotary cutter 32 beneath it to pivot conjointly with the shaft of the worm gear 341, enabling tilt adjustment of the rotary cutter 32 within a vertical plane perpendicular to the machine's travel direction. Concurrently, actuation of the second servo motor 37 rotates the rotating sleeve 334, driving the rotary frame 34 and the underlying linkage frame 35 and rotary cutter 32 to pivot about the short shafts 333. During this motion, the worm gear 341 follows the linkage frame 35 in revolving about the short shafts 333. The first servo motor 36 synchronously drives the worm 332 to rotate in tandem with the worm gear 341, thereby maintaining the worm gear 341 in a non-rotating state about its own axis while revolving with the linkage frame 35. This enables pitch adjustment of the rotary cutter 32 within a vertical plane parallel to the machine's travel direction. Collectively, these dual-axis adjustments allow real-time optimization of the rotary cutter's orientation in response to varying contour profiles of the tea canopy surface. This ensures superior harvesting of tea shoots while maintaining consistent plucking quality.

The second positioning hole 22 is divided, from bottom to top, into a lower vertical hole 221, a horizontal linking passage 222, and an upper vertical hole 223. The lower vertical hole 221 is formed at a rearward position on the sidewall of the fixed guide rail assembly 20 parallel to the machine's travel direction, constituting a vertically elongated slot. The upper vertical hole 223 is disposed on the rear side wall of the fixed guide rail assembly 20 as another vertically elongated slot, with its lower end disposed higher than the storage bin 50. The horizontal linking passage 222 extends horizontally from the top end of the lower vertical hole 221 to the top end of the upper vertical hole 223, thereby interconnecting the two vertical holes. A second lead screw 27 is vertically and rotatably disposed within the fixed guide rail assembly 20. A second nut seat 28 is threadedly engaged with the second lead screw 27. The second lead screw 27 is positioned equidistant from the vertical centerline of the lower vertical hole 221 and the vertical centerline of the upper vertical hole 223, as measured perpendicular to the machine's travel direction. A second drive motor 14 is disposed on the base 10. The output shaft of the second drive motor 14 is connected to the bottom end of the second lead screw 27 via a second reducer 15, configured to drive rotation of the second lead screw 27.

The collecting mechanism 40 comprises a sliding rod 41 slidably disposed within the second positioning hole 22. The inner end of the sliding rod 41 is fixedly connected to the second nut seat 28, thereby positively driving the sliding rod 41 to move synchronously with the second nut seat 28. A pivoting lever 42 is rotatably mounted at the outer end of the sliding rod 41, with a gathering hopper 44 rigidly affixed to the outer end of the pivoting lever 42. The gathering hopper 44 extends parallel to the rotary cutter 32 along their respective longitudinal axes. During installation, sufficient frictional torque is established between the pivoting lever 42 and the sliding rod 41 to prevent spontaneous rotation of the pivoting lever 42 under external disturbances. These disturbances include contact forces between the gathering hopper 44 and tea bushes, wind loads, and machine jolting. This frictional retention ensures positional stability of the gathering hopper 44 throughout operational conditions. When the sliding rod 41 moves within the lower vertical hole 221 or the upper vertical hole 223, it is horizontally constrained by the sidewalls of these holes. This constraint forces the sliding rod 41 and the second nut seat 28 to undergo purely vertical movement along the holes in response to rotation of the second lead screw 27, thereby driving vertical displacement of the gathering hopper 44. During traversal of the horizontal linking passage 222, the sliding rod 41 becomes vertically constrained by the upper and lower boundaries of the passage while being freed from horizontal restrictions. Consequently, rotation of the second lead screw 27 drives the second nut seat 28 and sliding rod 41 to pivot horizontally along the contour of the linking passage 222. This pivotal motion swings the gathering hopper 44 from a position rearward of the picking mechanism 30 to above the storage bin 50, accomplishing transfer of tea shoots.

Further, a vertically disposed first rack 24 is provided on a side of the lower vertical hole 221 proximate to the upper vertical hole 223, extending throughout its length along the central region of the lower vertical hole 221. A vertically disposed second rack 23 is arranged on a side of the upper vertical hole 223 proximate to the lower vertical hole 221. A gear 43 is rigidly mounted on the pivoting lever 42 and is selectively engageable with both the first rack 24 and the second rack 23. When the sliding rod 41 is positioned in the lower segment of the lower vertical hole 221, the opening of the gathering hopper 44 faces toward the rotary cutter 32, with its bottom edge consistently aligned with the rear edge of the rotary cutter 32 to optimize collection of harvested tea shoots. As the sliding rod 41 slides upward within the lower vertical hole 221, the gear 43 engages the first rack 24 upon reaching its height level. This engagement drives clockwise rotation of the gear 43, thereby rotating the gathering hopper 44 clockwise. Consequently, the opening side of the gathering hopper 44 tilts upward, consolidating tea shoots within the hopper and preventing spillage during subsequent movements. During upward travel of the sliding rod 41 within the upper vertical hole 223, the gear 43 engages the second rack 23 at its corresponding height. This engagement drives counterclockwise rotation of the gear 43, thus rotating the gathering hopper 44 counterclockwise. This motion tilts the opening side of the gathering hopper 44 downward, discharging the tea shoots into the underlying storage bin 50. Thus, only a single drive motor is required to simultaneously achieve three distinct motions of the gathering hopper 44 within the second positioning hole 22: vertical lifting, horizontal pivoting, and self-tilting. This integrated motion sequence accomplishes the collection, transportation, and discharge of tea shoots while minimizing actuation components, resulting in a streamlined mechanical arrangement with enhanced reliability.

The control system 60 comprises a control cabinet 61 disposed on the base 10 at the rear side of the fixed guide rail assembly 20. Within the control cabinet 61, a rechargeable battery 62 and a controller 63 are housed. The rechargeable battery 62 supplies electrical power to all mechanisms, while the controller 63 governs the operational movements of these mechanisms. A mounting frame 51 is provided on the control cabinet 61, within which the storage bin 50 is seated.

Mounted on the front portion of the top surface of the fixed guide rail assembly 20 are a LiDAR 70 and an industrial camera 80. The LiDAR 70 and industrial camera 80 are configured to identify terrain information of the tea plantation. This data is processed by the controller 63 to plan navigation paths for the traveling mechanism 11, enabling autonomous navigation of the equipment. A depth-sensing camera 90 is disposed on the top surface of the fixed guide rail assembly 20, laterally adjacent to the picking mechanism 30. The depth-sensing camera 90 serves to capture and interpret tea canopy surface profiles. This spatial data is processed by the controller 63 to dynamically adjust both the picking height and angular orientation of the picking mechanism 30 during harvesting operations.

The operational principle of the single-row self-propelled automatic harvesting equipment for premium tea shoots in this embodiment is as follows: The LiDAR 70 and industrial camera 80 identify terrain topography and tea row positioning data. The controller 63 controls the traveling mechanism 11 to propel the entire machine along the tea row. The depth-sensing camera 90 captures real-time tea canopy surface profiles. The controller 63 analyzes canopy height and tea shoot distribution, then controls the first drive motor 12 to rotate the first lead screw 25, adjusting the harvesting height of the rotary cutter 32. Subsequently, it controls the first servo motor 36 and second servo motor 37 to regulate the angular orientation of the rotary cutter 32, ensuring optimal harvesting efficacy. Synchronously, the controller 63 operates the second drive motor 14 to rotate the second lead screw 27, adjusting the height of the gathering hopper 44 to maintain alignment with the rotary cutter 32. When tea shoots within the gathering hopper 44 reach a preset volume, the rotary cutter 32 ceases operation. The controller 63 then commands the second drive motor 14 to rotate the second lead screw 27, driving the sliding rod 41 to lift the pivoting lever 42 and gathering hopper 44 upward. Upon the gear 43 reaching the elevation of the first rack 24, it engages the first rack 24, driving the pivoting lever 42 and gathering hopper 44 to rotate clockwise. This motion tilts the opening side of the gathering hopper 44 upward at a defined angle. The sliding rod 41 then drives the pivoting lever 42 and gathering hopper 44 to pivot horizontally along the horizontal linking passage 222 to the rear side of the fixed guide rail assembly 20, positioning the gathering hopper 44 above the storage bin 50. When the gear 43 reaches the height of the second rack 23, it engages the second rack 23, driving the pivoting lever 42 and gathering hopper 44 to rotate counterclockwise. This tilts the opening side of the gathering hopper 44 downward until the opening reaches a horizontal plane, fully discharging the tea shoots into the underlying storage bin 50. Finally, the controller 63 reverses the second drive motor 14 to rotate the second lead screw 27 in the opposite direction, returning the gathering hopper 44 to its collection position aligned with the rotary cutter 32, whereupon harvesting operations resume.

The foregoing describes only preferred embodiments of the present invention. The scope of protection is not limited to the embodiments disclosed herein. Any technical solution conceived under the inventive concept of the present invention shall fall within the scope of protection. It should be noted that those of ordinary skill in the art may make various modifications and refinements without departing from the fundamental principles of the present invention. Such modifications and refinements shall also be regarded as falling within the scope of protection of the present invention.

1. A single-row self-propelled automatic harvesting equipment for premium tea shoots comprises a base, wherein a traveling mechanism is arranged at the bottom of the base, and is characterized in that: a fixed guide rail assembly, a picking mechanism, a collecting mechanism, a storage bin and a control system are arranged on the base; the picking mechanism is slidably arranged in the first positioning hole, and is used for picking and cutting tea shoots and conveying them backward; The collecting mechanism comprises a sliding rod slidably arranged in the second limiting hole, the outer end of the sliding rod is rotatably arranged with a rotating rod, the rotating rod is fixedly arranged with a gear wheel, and the outer end of the rotating rod is arranged with a gathering hopper; the control systems are used to power the mechanisms and control their movements.

2. The single-row self-propelled automatic harvesting equipment for premium tea shoots according to claim 1, characterized in that: a first rack is vertically disposed on a side of the lower vertical hole proximate to the upper vertical hole; wherein when the sliding rod slides upward within the lower vertical hole, the gear engages with the first rack, causing the gathering hopper to rotate clockwise.

3. The single-row self-propelled automatic harvesting equipment for premium tea shoots according to claim 1, characterized in that: a first lead screw is vertically and rotatably disposed within the fixed guide rail assembly; a first nut seat is threadedly engaged with the first lead screw; the picking mechanism comprises a cantilevered arm having an inner end slidably disposed in the first positioning hole; the first nut seat is fixedly connected to the inner end of the cantilevered arm; a first drive motor is disposed on the base; and an output shaft of the first drive motor is connected to a bottom end of the first lead screw via a first reducer.

4. The single-row self-propelled automatic harvesting equipment for premium tea shoots according to claim 1, characterized in that: a mounting bracket is disposed under the cantilevered arm; two vertical plates are spaced apart within the mounting bracket; a worm is rotatably disposed between the two vertical plates parallel to the cantilevered arm; a short shaft is respectively mounted on an outer side of each vertical plate facing away from the other; a rotating sleeve is rotatably fitted over each short shaft; a rotary frame is commonly connected below the two rotating sleeves; a worm gear meshing with the worm is rotatably mounted within the rotary frame; both ends of a shaft of the worm gear extend through the rotary frame and are commonly connected to a linkage frame below; and a rotary cutter is disposed at a bottom of the linkage frame.

5. The single-row self-propelled automatic harvesting equipment for premium tea shoots according to claim 4, characterized in that: a first servo motor and a second servo motor are respectively disposed at two ends within the mounting bracket; an end of the worm proximate to the first servo motor extends through the corresponding vertical plate and the corresponding short shaft and is connected to an output shaft of the first servo motor; and an output shaft of the second servo motor is connected to the corresponding rotating sleeve.

6. The single-row self-propelled automatic harvesting equipment for premium tea shoots according to claim 1, characterized in that: a second lead screw is vertically and rotatably disposed within the fixed guide rail assembly; a second nut seat is threadedly engaged with the second lead screw; the second nut seat is fixedly connected to an inner end of the sliding rod; a second drive motor is disposed on the base; and an output shaft of the second drive motor is connected to a bottom end of the second lead screw via a second reducer.

7. The single-row self-propelled automatic harvesting equipment for premium tea shoots according to claim 1, characterized in that: the control system comprises a control cabinet disposed on the base; a rechargeable battery and a controller are disposed within the control cabinet; the rechargeable battery supplies electrical power to the mechanisms; and the controller is configured to control the movements of the mechanisms.

8. The single-row self-propelled automatic harvesting equipment for premium tea shoots according to claim 7, characterized in that: the control cabinet is disposed on a rear side of the fixed guide rail assembly; a mounting frame is arranged on the control cabinet; and the storage bin is placed within the mounting frame.

9. The single-row self-propelled automatic harvesting equipment for premium tea shoots according to claim 1, characterized in that: a laser scanner and an industrial camera are disposed on a front portion of a top of the fixed guide rail assembly; the laser scanner and the industrial camera are configured to identify terrain information of a tea plantation and, via the controller, plan a travel path for the traveling mechanism; a depth camera is disposed on the top of the fixed guide rail assembly adjacent to the picking mechanism; and the depth camera is configured to identify tea canopy surface information and, via the controller, adjust a picking height and a picking angle of the picking mechanism.
